(19) United States
(12) Patent Application Publication
(10) Pub. No.: US 2018/0129461 A1
(43) Pub. Date: May 10, 2018

(54) METHOD AND SYSTEM FOR ADVERTISING AND SCREEN IDENTIFICATION USING A MOBILE DEVICE TRANSPARENT SCREEN

(71) Applicant: SK Commercial Construction, Inc., Belton, TX (US)

(72) Inventor: Suk K. Kim-Whitty, Belton, TX (US)

(21) Appl. No.: 15/464,231

(22) Filed: Mar. 20, 2017

Related U.S. Application Data
(60) Provisional application No. 62/420,539, filed on Nov. 10, 2016.

(51) Int. Cl. G06F 3/14; G06F 3/0346; G06T 11/60; G06T 3/20

(52) U.S. Cl. CPC G06F 3/1446; G06F 3/0346; G06T 2210/62; G06T 3/20; G06T 11/60

(57) ABSTRACT

A method and system for advertising and screen identification using an electronic mobile device transparent screen. The display may include one or more display screens varying in translucency on the rear display screen. Advertisements delivered to the electronic mobile devices by virtue of a mobile app are displayed on the electronic device screen outside the confines or borders of the mobile app. Advertisements are viewed on a rear display screen to non-users of the electronic mobile device. Advertisements are displayed based on GPS location of the electronic mobile device.

### CROSS REFERENCE TO RELATED APPLICATIONS

This application claims benefit to the provisional application No. 62/420,539 filed on 10 Nov. 2016 and is incorporated herein by reference.

### FIELD OF THE INVENTION

The present disclosure relates generally to mobile electronic devices with a transparent display screen. The disclosure further relates to a method and systems method for advertising and screen identification using a mobile device transparent screen.

### BACKGROUND OF THE ART

Advertisement and displaying of information on electronic devices has been a rising industry and sales marketing tool in today's business market. These electronic devices, e.g. computers, mobile devices (smartphone and/or tablets), have been increasingly employed in the advertising screen or banner. The vast majority of advertising platforms and models utilizing such electronic devices randomly provide advertisements with web page links, email links, and contemporaneously with mobile applications and games, or via spam in email.

Examples of advertising platforms utilizing mobile devices for advertisement are provided herein below.

U.S. Pat. No. 9,367,093 to Pence discloses a method and system for displaying images on a transparent display of an electronic device. The display includes one or more display screens as well as a flexible circuit for connecting the display screens with internal circuitry of the electric device. Furthermore, the display screens allow for overlaying of images over real world viewable objects, as well as a visible window to be present on an otherwise opaque display screen. Additionally, the display includes active and passive display screens that are utilized based on images to be displayed.

U.S. Patent Application Publication No. 20140188614 to Badenhop discloses a mobile billboard messaging icon displaying messages related to a user's preferences from an advertiser's on the display of a user's devices, such as Smartphone or tablet, having internet connectivity, location technology, and logic means for determining when the user device is in a given vicinity of the advertiser's location. The coordinate location of the device is used to identify advertiser's locations within a preselected distance that correlate with user's preferences. Where a correlation is found, at least one message from the advertiser is displayed on the Smartphone or tablet device. The message is triggered when the device enters within the given radii from the advertiser. When triggered, the messaging icon provides relevant real-time promotions, deals and coupons for purchase of goods and services of the advertisers or sponsors related to the user preferences. The mobile billboard displays target messages based on both the user's specific preferences and the user's geographical real-time location.

U.S. Patent Application Publication No. 20140188616 to Badenhop discloses a mobile billboard messaging app and non-transitory computer readable electronic storage medium. The method includes a computer database electronically storing merchant/advertiser and user information in communication with a software application running in a mobile device of the user. The mobile device has GOS technology, a display screen and Internet connectivity. The method displays on the user's device messages from an advertiser that are logically related to user preferences when the user device is in a given location radii. Where a correlation is found, at least one message from the advertiser is displayed. The message is triggered when the device enters within the given radii from the advertiser. When triggered, the messaging app provides relevant real-time promotions, deals and coupons related to the user preferences. The mobile billboard displays target messages based on both the user's preferences and the user's geographical real-time location.

U.S. Patent Application Publication No. 20150039440 to Doumet discloses a method and system for displaying images on ads delivered to mobile devices by virtue of a mobile app executing on the device are displayed on the device screen outside the confines or borders of the mobile app. This enables app developers to display ads through their apps to app users wherein the ads are displayed outside the confines of the actual app as displayed on the device. That is, the ad may be displayed as what may be characterized as a ‘regular non-app generated’ ad, such as on the device's home or lock screen (display areas not normally associated with an app). In this manner, clutter is decreased within mobile apps that would otherwise be caused by the ads. Consequently, advertisers are more likely to pay higher rates thereby generating more revenue for app developers or related entities.

None of the heretofore disclosed and/or utilized systems or methods provide utilization of a rear side of transparent display screen to advertise and display an advertisement image, while the electronic mobile device is held up in front of the device user. This in such a manner as to is not in transparent mode or the device is next to the user's ear.

Additionally none of the heretofore disclosed and/or utilized systems or methods provide a mobile electronic device with transparent display screen to display reversed images, text or advertisement from an apps to be read from the rear of the electronic mobile device.

Additionally, none of the heretofore disclosed and/or utilized systems or methods provides a mobile electronic device with multiple transparent display screen layers that can use one of the middle layers of transparent display screen to be black/white out, partial or full (used as divider from front and rear display screen) to display image A in the front and image B in the rear at the same time. Image B in the rear of the screen may display selected image, text or advertisement from apps.

Additionally, none of the heretofore disclosed and/or utilized systems or methods provides an electronic mobile device utilizing sensors on a circuit board to display a transparent screen. The electronic mobile device screen may go blank if the device is showing an image on the rear of the transparent screen. Furthermore, the rear side of the transparent display screen may show a message to the user. The message informing the user to turn the device around if the front or intended display side is not correctly facing the device owner.

Additionally, none of the heretofore disclosed and/or utilized systems or methods provides a multiple layered transparent and/or translucent display screen with rear images that may be shown in different colors, patterns or a combination thereof, to alert the device user of proper orientation. This feature may be beneficial for map/speed apps, which show directional symbols, letters or numbers which may be read in reversed manner.

### BRIEF SUMMARY OF THE INVENTION

The present disclosure details method and system that displays digital advertisements on a front surface and a rear surface of a transparent display screen of an electronic mobile electronic device. The electronic device may include a housing, sensors, a display screen.

The display screen may have a front display screen on a front surface and a rear display screen on a rear surface such that the front surface and the rear surface are on opposing sides of the electronic mobile device.

The electronic mobile device may include processors, non-transitory memory units that may be configured to execute a method to display advertisements, images, texts, alerts and a combination thereof.

The present disclosure may allow non-users of an electronic mobile device to view information, advertisements, amber alerts and a combination thereof, on a rear screen of the transparent display screen.

While the present disclosure is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

In light of the present disclosure, here appears a method and system for advertising and screen identification using an electronic mobile device display screen that enables a non-user of the electronic display device to view advertisements and severe alerts and/or information.

The method may be utilized for advertising and screen identification using the electronic mobile device display screen. The method may display one or more active advertisement images on a display screen of the electronic mobile device.

In some embodiments the display screen of the electronic mobile device may be within a visible range from a non-user. In these embodiments the mobile device may comprise a front display screen on a front surface and a rear display screen on a rear surface, such that the front surface and the rear surface are on opposing sides of the electronic mobile device.

In some embodiments, the displaying one or more active advertisement image may include projecting the active advertisement image on the rear surface of the display screen of the electronic mobile device when the electronic mobile device may be at an angle of at least 180 degrees to the side of a user's face.

In some embodiments, the front display screen and the rear display screen may be selectively controlled to simultaneously display different active advertisement images on the front and rear surfaces, respectively.

In some embodiments, the different active advertisement may include one or more predetermined digital advertisements for providing a dual display of advertisements for non-users of the mobile device.

In some embodiments, sensors may be activated to determine the location of the electronic mobile device. The sensors may be embedded within the electronic mobile device which may allow the predetermined digital advertisements to display relative to the location of the determined location of the electronic mobile device.

In some embodiments, sets of computer instructions may be on the electronic mobile display device that may be executed to display on the rear surface of the display screen. In such embodiment, the sets of computer instructions may determine which of a set of predetermined user interface application programs on the mobile device is operating and may communicate information relating to the user interface application programs as an advertisement.

In some embodiments, digital advertisements may be displayed on the rear display screen by inputting computer instructions operating on the electronic mobile device to execute predetermined user interface programs.

In some embodiments the digital advertisements may be an amber alert, weather alert public safety information, or a combination thereof.

In some embodiments, the invention may correlate a plurality of said transparent display screens of the electronic mobile device, such that the plurality of transparent screens translucence range is greater than zero translucence to full transparence.

In some embodiments, may adjust the translucence of the front and rear display screen by selectively controlling the front display screen and the rear display screen simultaneously. The translucence may range from greater than zero translucence to full transparence.

Embodiments of the present disclosure may selectively control the front display screen and the rear display screen simultaneously, which may include adjusting the translucence of the front and rear display screen. In these instant embodiments, the translucence may range from zero to 20% translucence. Furthermore, the active display images may be an essentially full screen graphical image or an user interface text image.

Embodiments of the present disclosure may selectively control the front display screen and the rear display screen simultaneously, which may include displaying active display images as a reflective reverse image of an essentially full screen image on the rear display screen.

Embodiments of the present disclosure may selectively control the front display screen and the rear display screen simultaneously, which may include displaying active display images as non-color shaded images for assisting a user to recognize the orientation of said active display images.

Embodiments of the present disclose may selectively control the front display screen and the rear display screen simultaneously, which may include displaying active display images reverse characters, images or a combination thereof, for indicating a proper display orientation of said active display images.

### BRIEF DESCRIPTION OF THE DRAWINGS

The novel features believed characteristic of the disclosed subject matter will be set forth in any claims that are filed later. The disclosed subject matter itself, however, as well as the preferred mode of use, further objectives, and advantages thereof, will best be understood by reference to the following detailed description of an illustrative embodiment when read in conjunction with the accompany drawings, wherein:

Having thus described the invention in general terms, reference will now be made to the accompanying drawings, which are not necessarily drawn to scale, and wherein:

FIG. 1 is a perspective view illustrating an electronic mobile device with dual transparent screens, in accordance with one embodiment of the present invention.

FIG. 2 is a view illustrating an electronic mobile device with a transparent screen and a rear display screen varying translucency display screen, in accordance with one embodiment of the present invention.

FIG. 3 is a perspective view illustrating the rear display screen of the electronic device of FIG. 2, in accordance with one embodiment of the present invention.

FIG. 4 is a perspective view of an electronic mobile device varying the pattern of a digital image on the rear display screen, in accordance with one embodiment of the present invention.

FIG. 5 is a perspective view of an electronic mobile device varying the pattern of a digital image and mirroring the digital image on the rear display screen, in accordance with one embodiment of the present invention.

FIG. 6 is a perspective view of an electronic mobile device with the digital image mirrored on the rear display screen, in accordance with one embodiment of the present invention.

FIG. 7 illustrates an electronic mobile device displaying an advertisement, in accordance with an embodiment of the present invention.

### DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all the possible embodiments and contexts of the invention in this disclosure. Upon reading this disclosure, many alternative embodiments of the present invention will be apparent to the persons ordinary skill in the art.

Method and system for displaying ads on a mobile device through execution of an app, wherein the ads may be displayed outside the confines of the app as displayed on the transparent display screen are described in the forthcoming figures.

The present disclosure enable app developers to display ads through their apps to app users wherein such ads may be displayed on a front display surface and a rear display surface of an electronic mobile transparent display device. That is, app developers may be able to display ads outside of the present app and onto a rear display surface such that non-users may view the ads. These methods decrease clutter within electronic mobile apps that are caused by ads, and allow more individuals view the ads. Consequently, advertisers may be more likely to pay higher rates thereby generating more revenue for app developers or related entities.

As noted, presently software developers designing electronic mobile apps running on mobile devices can generally only display ads within the confines of the app itself. However, Due to limited screen size of many electronic mobile devices, the constraint increases clutter within the apps making it difficult for users to enjoy the app and forcing ads to be displayed in small and confined areas within the app. This, in turn, decreases the quality and appeal of this form of electronic mobile advertising from the perspective of the advertisers, thereby driving down the economic value of such ads and negatively impacting revenues earned by software developers. Furthermore, revenues earned by software developers are limited because ads are no longer seen by users once an electronic mobile app is closed or shut down.

This disclosure, on the other hand, may empower electronic mobile app developers to display ads to their users as well as non-users wherein the ads are displayed from outside the confines of their mobile apps. This method may decrease clutter due to the ads, while providing an outlet for apps to display ads to their users and non-users and earn revenue from advertisers or ad publishers.

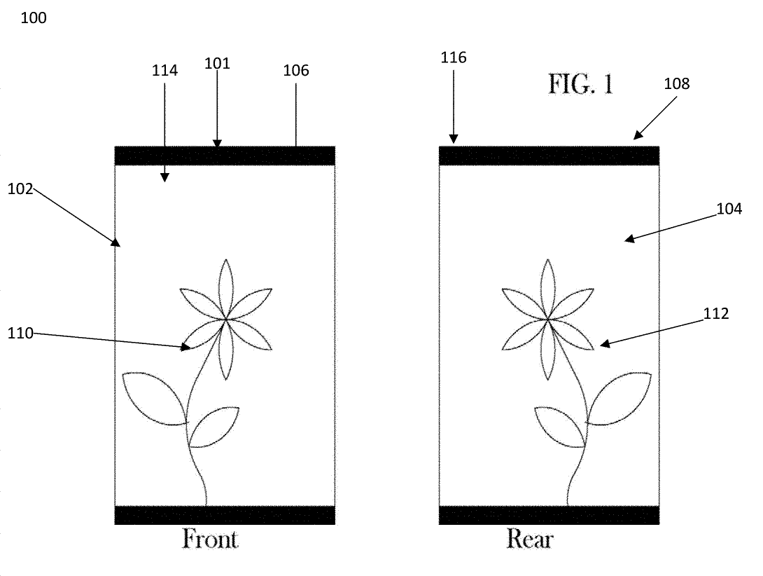

An electronic mobile device 100 is illustrated in FIG. 1 in accordance with one embodiment of the present disclosure. In some embodiments, including the presently illustrated embodiment, the device 100 may be a portable electronic device, such as a tablet computer. Other electronic devices may also include a cellular phone, a personal data organizer, viewable media player, another computer, or the like. Indeed, in such embodiments, a portable electronic mobile device may include a combination of the functionalities of such devices. In addition, the electronic mobile device 100 may allow a user to connect to and communicate through the Internet or through other networks, such as a local or wide area networks. For example, the electronic mobile device 100 may allow a user to access the Internet and to communicate using e-mail, text messaging, or other forms of electronic communication. In other embodiments, the electronic mobile device 100 may include other models and/or types of electronic devices employing a display, available from any manufacturer. Further the electronic mobile device 100 may include handheld devices (e.g., tablet computers and portable media players).

In certain embodiments, the electronic mobile device 100 may be powered by one or more rechargeable and/or replaceable batteries. Such embodiments may be highly portable, allowing a user to carry the electronic mobile device 100 while traveling, working, and so forth. While certain embodiments of the present disclosure are describe with respect to a portable electronic device, it should be noted that the presently disclosed techniques may be applicable to a wide array of other electronic devices and systems that are configured to render graphical data, such as a desktop computer.

In the presently illustrated embodiment, the electronic mobile device 100 includes an enclosure or housing 101. The housing 101 may be formed from plastic, metal, composite materials, or other suitable materials, or any combination thereof. The housing 101 may be, for example, a handheld housing for a handheld device. The housing 101 may protect the interior components of the electronic mobile device, such as processors, circuitry, and controllers, among others, from physical damage, and may shield the interior components from electromagnetic interference (EMI). In one embodiment, the housing 101may include one or more bezels that may support multiple display screens. The housing 101 may be formed in such a way to provide a support structure for the remaining elements illustrated in FIG. 1. Additionally, some or all of the housing may be made of transparent or translucent material to allow a user to see through the electronic mobile device.

As noted above, the device may include a front surface 106, that includes a front display screen 102. The front display screen 102 may be a liquid crystal display (LCD), which may be a light emitting diode (LED) based display or some other suitable display. For example, the LCD may be an organic light emitting diode display (OLED). Furthermore, as will be further discussed below, the front display screen 102 may include multiple display screens positioned in an overlaid manner such that images displayed on each of the display screens may be concurrently visible on the front display screen 102, as well as a rear display screen 104, on a rear surface 108. In other embodiments, however, the front display screen 102, may include a single display screen. Additionally, the front display screen 102, and the rear display screen 104, may be a touch screen display that allows a user to navigate a displayed user interface, such as a graphical user interface (GUI), and/or other applications running on the electronic mobile device 100. For example, a user may make selections and move a cursor by simply touching the front display screen 102 via a finger or stylus, which may be interpreted by the device 100 to perform an action based on the touch event.

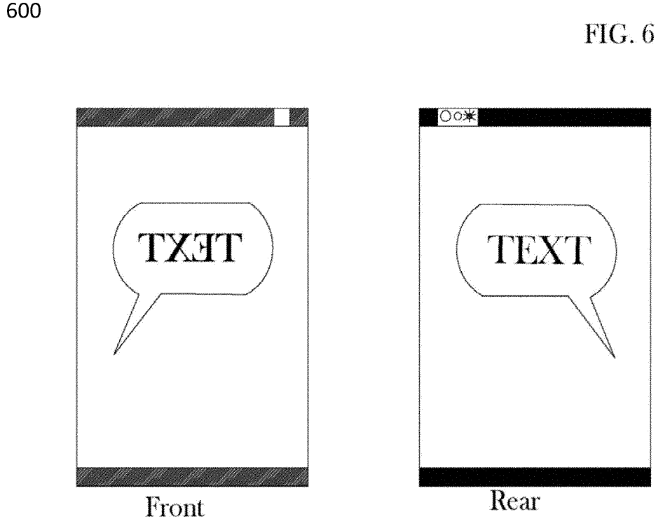

The front display screen 102 and the rear display screen 104 may be used to display one or more images, for example through the use of a liquid crystal substance typically disposed between two substrates, in the case of an LCD, or organic layers that operate to emit light, in the case of an OLED display. Furthermore, it should be noted that the front display screen 102 and the rear display screen 104, may be transparent. That is, light may pass through the front display screen 102 or the rear display screen 104 such that actual images behind the electronic mobile device 100 may be seen through the opposing display screen. In one embodiment, actual objects may be seen through the front display screen 102 and graphical overlays may be seen on the rear display screen 104. In other words, first and second digital images 110 and 112, on the front and rear surfaces, respectively, rendered by the electronic mobile device 100 may be visible on the front display screen 102 and the rear display screen 104, simultaneously. The first and second digital images 110 and 112 may be real-world objects, graphical images, advertisements from apps, emergency information, weather and/or amber alerts, and a combination thereof. As shown in FIG. 1, the second digital image 112 is a mirror image of the first digital image 110. In some embodiments, first and second digital images 110 and 112, on the front and rear surfaces, respectively, rendered by the electronic mobile device 100 may be visible on either the front display screen 102 and the rear display screen 104. FIG. 6 illustrates the reverse of the mirrored digital image. The first and second digital images 110 and 112 may be real-world objects, graphical images, advertisements from apps, emergency information, weather and/or amber alerts, and a combination thereof.

In one embodiment, the entire surface area of the front display screen 102 and the rear display screen 104 may be transparent, allowing a user to view real-world objects through the rear display screen 104. In another embodiment, one or more portions of the front display screen 102 or the rear display screen 104 may be transparent, while the remainder of the display screen may be opaque. In another embodiment, the electronic mobile device 100 may be virtually transparent. That is, the housing 101, the front display screen 102 and the rear display screen 104 are made of a transparent material.

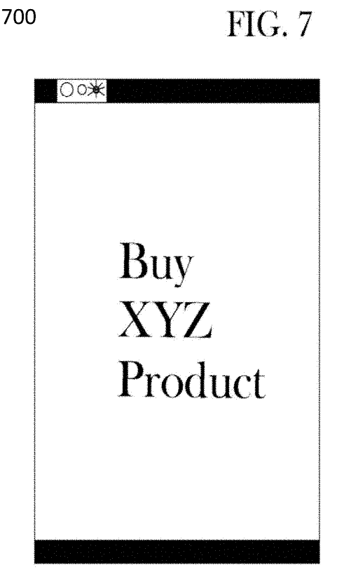

The electronic mobile device, according to some embodiments, may have Internet and GPS connectivity. Advertisements may be displayed on the front display screen 102. In some embodiments, the advertisements from an app may be displayed to non-users by way of the rear display screen 104. An app developer may have an app on the electronic mobile device that displays messages targeted to a user's GPS location The GPS coordinate location of the electronic mobile device may be used to identify advertiser's locations within a preselected distance that correlates with the user's preferences. Where a correlation is found, at least one message from the advertiser may be displayed on the electronic mobile device front display screen 102, rear display screen 104, or a combination thereof. The message may be triggered when the device enters within the given radii from the advertiser. Upon being triggered, the messaging app may provide relevant real-time promotions, deals and coupons for purchase of goods and services of the advertisers or sponsors related to the users preferences. This may allow the advertisers to reach a larger mass of potential buyers. FIG. 7 illustrates an advertisement in accordance to the present embodiment.

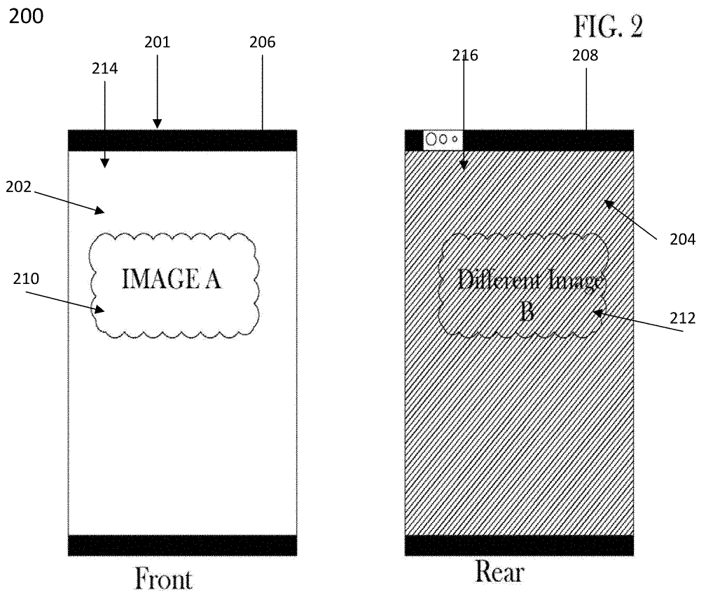

FIG. 2 is an illustration of an embodiment of the present invention including an electronic mobile device 200. It should be noted that FIG. 2 (as well as some subsequent figures) shows an electronic mobile device with similar reference numerals. In these cases, unless otherwise noted, the numerals are the same elements as described in FIG. 1, for sake of explanation. As shown in FIG. 2, electronic mobile device 200 includes a rear surface 208 with a rear display screen 204. In some embodiments, the rear display screen 204 may be partially translucent. A user of the electronic mobile device may want to ensure privacy of the information on the front display screen 202. In this case, the translucency of the rear display screen 204. The translucency may range from 0 to 20 percent, in comparison to the front display screen's transparency range.

As shown in FIG. 2, the first digital image 210 may be different from the second digital image 212. This may allow an user of the electronic mobile device 200 to push the advertisement within the app to the rear display screen 204 to allow non-user's to view the advertisement. The translucency of the rear display screen 204 may be low, 0 percent, for instance, such that the digital image 212 may be viewed clearly by the non-user.

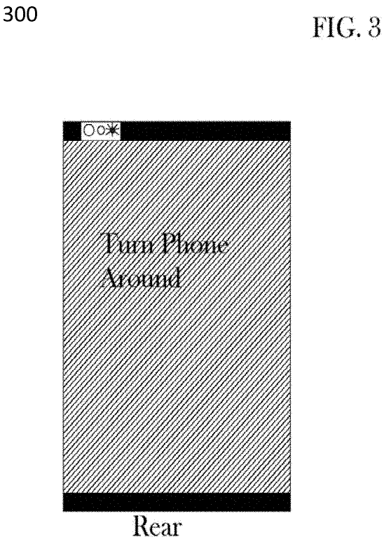

FIG. 3 is an illustration of an embodiment of the present invention where the electronic mobile device 300 may display a message indicating the user to perform a specific function.

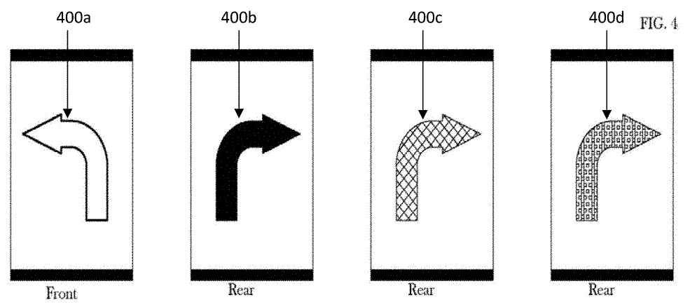

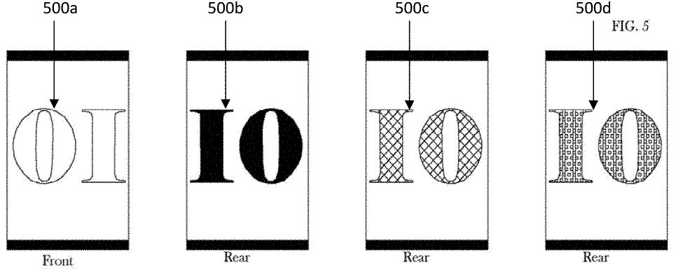

FIGS. 4-5 illustrate an embodiment of the present invention that may assist user's or non-user's with color blindness. Some people have a color vision deficiency, which means their perception of colors is different from what most others see. The most severe forms of these deficiencies are referred to as color blindness. People with color blindness are not aware of differences among colors that are obvious to others. In the case of color blindness, most individuals will say that a strawberry is red in color. Various cases occur where individuals with color blindness will see the strawberry as orange. Other examples include yellow appearing greener and colors are not as bright. In other cases, read appears black and certain shades of orange, yellow and green appear green. Furthermore, others may perceive red as black and yellow and green appear redder and difficulty lies with distinguishing violet from purple.

In each of the cases of color blindness, FIGS. 4-5 correct this by adding patterns and texture to the digital images 400a, 400b, 400c, 400d, 500a, 500b, 500c, 500d. This allows advertisers within the electronic mobile app to effectively advertise the goods to non-users suffering from color blindness.

Advantages are rendered through practice of the disclosed method and system for advertising and screen identification using an electronic mobile device. The disclosed invention empowers advertisers, directly and indirectly, to deliver advertisement to potential customers through target advertisement notifications to users and non-users of the electronic mobile device. Furthermore, the present invention may attract and excite a diverse audience of the electronic mobile device users and non-users with a mobile application that will allow them to receive notifications and alerts on discounts, promotions and savings specific to location of the electronic mobile device. The user of the electronic mobile device may display advertisements on a screen such that non-users are able to view the advertisement. Emergency alerts may be displayed to non-users of the device. Furthermore, advertisements may be tailored to individuals suffering from color-blindness.

The benefits and advantages that may be provided by the present invention has been described above with regard to specific embodiments. These benefits and advantages, and any elements or limitations that may cause them to occur or to become more pronounced are not to be construed as critical, required, or essential features of any of any or all of the claims. As used herein, the singular forms “a”, “an”, and “the” are intended to include the plural forms as well, unless the context clearly indicates otherwise. It is further understood that the terms “comprises” and/or “comprising” or “includes” and/or including”, or any other variation thereof, are intended to be interpreted as nonexclusively including the elements or limitations which follow those terms. Accordingly, a system, method, or other embodiment that comprises a set of elements is not limited to only those elements, and may include other elements not expressly listed or inherent to the claimed embodiment. These terms when used in this specification, specify the presence of stated features, regions, integers, steps, operations, elements, and/or components, but do not preclude the presence or addition of one or more features, regions, integers, steps, operations, elements, components, and/or groups thereof.

1. A method for operating a mobile, hand-held, electronic communications device for displaying images on a transparent display screen, advertising and screen identification using a mobile device display screen comprising the steps of:
using a processor to execute processor instructions stored in a non-transitory memory coupled to said processor, said non-transitory memory and said processor within a housing of a mobile, hand-held, electronic communications device;
said processor instructions comprising instructions for operating a transparent display screen forming an integral portion of said housing, said transparent display screen comprising a first transparent display screen portion and a second transparent display screen portion,
associating said first transparent display screen portion and said second transparent display screen portion associated to form opposing display interfaces on said housing;
visibly separating said opposing display interfaces using a selectably opaque layer between said first transparent display portion and said second transparent display screen portion;
selectably operating said second transparent display screen portion associated with said first transparent display screen portion for either independent or collaborative operation with said first transparent display screen portion,
in response to execution by the processor of the processor instructions, causing the mobile, hand-held, electronic communications device to at least:
control said first transparent display screen portion as a user interface for displaying images relating to using said mobile, hand-held, electronic communications device as a telecommunications device between the user and one of more parties with whom the user directly communicates; and
determine a defined geographical or positional radius according the position of said mobile, hand-held, electronic communications device and communicating said defined geographical or positional radius to source for a plurality of non-user third party notification messages;
control said second transparent display screen portion for displaying to said non-user third party notification messages comprising images from the group consisting of real-world objects, graphical images, textual and graphical advertisements, emergency information, weather and/or amber alerts, and combinations thereof wherein said non-user third party comprises at least one of a group of individuals located within a defined geographical or positional radius of the user; and
wherein, as the user positions said first transparent display screen portion proximal to his face in using said first transparent display screen portion as a user interface for direct communication to the one or more parties, simultaneously the user also positions said second transparent display screen portion for displaying said notification messages to the non-user third party viewing the user in communication with the one or more parties, such that by the user positioning said first transparent display screen portion proximal to his face, the user increases the safety and/or well-being of said third-party non-user within said defined geographical or positional radius by virtue of said third-party non-user seeing said third-party notification messages.

2. The method of claim 1, further comprising the step of activating one or more sensors to determine the location of said electronic mobile device;
wherein the one or more sensors are embedded within the electronic mobile device;
displaying the notification messages one or more predetermined digital advertisements relative as textual and graphical advertisements to the location of the determined location of the mobile device.

3. (canceled)

4. The method of claim 1, further comprising executing one or more sets of computer instructions on said electronic mobile device to display on said rear surface of the display screen;
wherein the one or more sets of computer instructions determines for determining which of a set of predetermined user interface application programs on said electronic mobile device is operating and communicate information relating to said user interface application programs as an advertisement said notification messages being said textual and graphical advertisements.

5. The method of claim 3, further comprising inputting one or more computer instructions operating on said electronic mobile device mobile, hand-held, electronic communications device to execute one or more predetermined user interface programs to display the one or more digital advertisements notification messages comprising images from the group consisting of real-world objects, graphical images, textual and graphical advertisements on the rear display screen said second transparent display screen portion.

6. The method of claim 4, wherein the one or more digital advertisements notification messages comprises an amber alert, public safety information, or a combination thereof.

7. The method of claim 4, wherein the one or more digital advertisements notification messages comprises a weather alert, public safety information, or a combination thereof.

8. The method of claim 1, further comprising correlating a plurality of said transparent display screens of said electronic mobile device mobile, hand-held, electronic communications device, wherein said plurality of transparent screens translucence range is greater than zero translucence to full transparence.

9. The method of claim 1, wherein selectively controlling said first transparent display screen portion front display screen and said second transparent display screen portion rear display screen simultaneously further comprises adjusting the translucence of said first transparent display screen portion and said second transparent display screen portion wherein the translucence range is greater than zero translucence to full transparence.

10. The method of claim 1, wherein selectively controlling said first transparent display screen portion and said second transparent display screen portion front display screen and said rear display screen simultaneously includes adjusting the translucence of said first transparent display screen portion and said second transparent display screen portion;
wherein the translucence ranges from zero to 20% translucence;
wherein the one or more notification messages further comprises active display images is an essentially full screen graphical image.

11. The method of claim 1, wherein selectively controlling said front display screen and said rear display screen said first transparent display screen portion and said second transparent display screen portion simultaneously includes adjusting the translucence of the front and rear display screen said first transparent display screen portion and said second transparent display screen portion;
wherein the translucence ranges from zero to 20% translucence;
wherein the one or more notification messages comprises active display images is a user interface text image.

12. The method of claim 1, wherein selectively controlling said first transparent display screen portion and said second transparent display screen portion front display screen and said rear display screen simultaneously includes displaying the one or more active display images as a reflective reverse image of an essentially full screen image on the rear display screen.

13. The method of claim 1, wherein selectively controlling said first transparent display screen portion and said second transparent display screen portion front display screen and said rear display screen simultaneously includes displaying the one or more active display images as non-color shaded images for assisting a user to recognize the orientation of said active display images.

14. The method of claim 1, wherein selectively controlling said first transparent display screen portion and said second transparent display screen portion front display screen and said rear display screen simultaneously includes displaying the one or more active display images reverse characters, images or a combination thereof, for indicating a proper display orientation of said active display images.

15. A mobile, hand-held, electronic communications device for displaying images on a transparent display screen, system for advertising and screen identification using an electronic mobile device display screen comprising:
an electronic mobile device;
wherein the electronic mobile device comprises:
a housing;
one or more sensors;
a display screen comprising a front display screen on a front surface and a rear display screen on a rear surface, wherein the front surface and the rear surface are on opposing sides of the electronic mobile device;
a processor within said housing; and
a non-transitory memory coupled to said processor that when executed by the processor are configured to perform a method, comprising:
displaying one or more active advertisement images on a display screen of a mobile device;
wherein the display screen of the mobile device is within a visible range from a non-user;
wherein displaying one or more active advertisement image includes projecting the said active advertisement image on the rear surface of the said display screen of the said electronic mobile device;
a transparent display screen forming an integral portion of said housing and comprising a first transparent display screen portion and a second transparent display screen portion,
said second transparent display screen portion associated with said first transparent display screen portion for selectable operation either independently of operation of said first transparent display screen portion or in collaboration with operation of said first transparent display screen portion, said first transparent display screen portion and said second transparent display screen portion associated to form opposing display interfaces on said housing, said opposing display interfaces controllably separated by a selectably opaque layer for visibly separating said first transparent display screen portion from said second transparent display screen portion;
the memory bearing processor instructions that, in response to execution by the processor, cause the mobile, hand-held, electronic communications device to at least:
control said first transparent display screen portion as a user interface for displaying images relating to using said mobile, hand-held, electronic communications device as a telecommunications device between the user and one of more parties with whom the user directly communicates; and
determine a defined geographical or positional radius according the position of said mobile, hand-held, electronic communications device and communicating said defined geographical or positional radius to source for a plurality of non-user third party notification messages;
control said second transparent display screen portion for displaying to said non-user third party notification messages comprising images from the group consisting of real-world objects, graphical images, textual and graphical advertisements, emergency information, weather and/or amber alerts, and combinations thereof wherein said non-user third party comprises at least one of a group of individuals located within a defined geographical or positional radius of the user; and
wherein, as the user positions said first transparent display screen portion proximal to his face in using said first transparent display screen portion as a user interface for direct communication to the one or more parties, simultaneously the user also positions said second transparent display screen portion for displaying said notification messages to the non-user third party viewing the user in communication with the one or more parties, such that by the user positioning said first transparent display screen portion proximal to his face, the user increases the safety and/or well-being of said third-party non-user within said defined geographical or positional radius by virtue of said third-party non-user seeing said third-party notification messages.

16. The system of claim 15, wherein the method further comprising activating the one or more sensors to determine the location of said mobile, hand-held, electronic communications device electronic mobile device;
displaying the one or more notification messages predetermined digital advertisements relative to the location of the determined location of the mobile, hand-held, electronic communications device mobile device.

17. The system of claim 15, wherein the method further comprising executing one or more sets of computer instructions on said mobile, hand-held, electronic communications device electronic mobile device to display on said rear surface of the display screen;
wherein the one or more sets of computer instructions determines which of a set of predetermined user interface application programs on said mobile, hand-held, electronic communications device mobile device is operating and communicate information relating to said user interface application programs as an advertisement.

18. The system of claim 18, wherein the method further comprising inputting one or more computer instructions operating on said mobile device to execute one or more predetermined user interface programs to display the one or more notification messages digital advertisements on said second transparent display screen portion the rear display screen.

19. The system of claim 18, wherein the one or more notification messages digital advertisements is an amber alert, public safety information, or a combination thereof.

20. The system of claim 18, wherein the one or more notification messages digital advertisements is a weather alert, public safety information, or a combination thereof.

21. The system of claim 15, wherein the method further comprising correlating a plurality of said transparent display screens of said mobile, hand-held, electronic communications device electronic mobile device, wherein said plurality of transparent screens translucence range is greater than zero translucence to full transparence.

22. The system of claim 15, wherein selectively controlling said first transparent display screen portion and said second transparent display screen portion front display screen and said rear display screen simultaneously further comprises adjusting the translucence of the said first transparent display screen portion and said second transparent display screen portion front and rear display screen;
wherein the translucence range is greater than zero translucence to full transparence.

23. The system of claim 15, wherein selectively controlling said first transparent display screen portion and said second transparent display screen portion front display screen and said rear display screen simultaneously includes adjusting the translucence of said first transparent display screen portion and said second transparent display screen portion the front and rear display screen;
wherein the translucence ranges from zero to 20% translucence;
wherein the one or more active display images is an essentially full screen graphical image.

24. The system of claim 15 elain 1 4, wherein selectively controlling said first transparent display screen portion and said second transparent display screen portion front display screen and said rear display screen simultaneously includes adjusting the translucence of said first transparent display screen portion and said second transparent display screen portion the front and rear display screen;
wherein the translucence range from zero to 20% translucence;
wherein the one or more active display images is a user interface text image.

25. The system of claim 15, wherein selectively controlling said first transparent display screen portion and said second transparent display screen portion front and rear display screen front display screen and said rear display screen simultaneously includes displaying the one or more active display images as a reflective reverse image of an essentially full screen image on the rear display screen.

26. The system of claim 15, wherein selectively controlling said first transparent display screen portion and said second transparent display screen portion front display screen and said rear display screen simultaneously includes displaying the one or more active display images as non-color shaded images for assisting a user to recognize the orientation of said active display images.

27. The system of claim 15, wherein selectively controlling said first transparent display screen portion and said second transparent display screen portion front display screen and said rear display screen simultaneously includes displaying the one or more active display images reverse characters, images or a combination thereof, for indicating a proper display orientation of said active display images.
